(19) United States
(12) Patent Application Publication
(10) Pub. No.: US 2026/0197813 A1
(43) Pub. Date: Jul. 9, 2026

(54) LOW LATENCY LOW OVERHEAD ESTIMATION OF PATHLOSS TO NEIGHBORING ACCESS POINTS

(71) Applicant: Cisco Technology, Inc., San Jose, CA (US)

(72) Inventors: Brian D. Hart, Sunnyvale, CA (US); Binita Gupta, San Diego, CA (US)

(21) Appl. No.: 19/555,249

(22) Filed: Mar. 3, 2026

Related U.S. Application Data
(63) Continuation of application No. 19/354,061, filed on Oct. 9, 2025.
(60) Provisional application No. 63/717,341, filed on Nov. 7, 2024.

(51) Int. Cl. H04W 72/044; H04W 74/0816

(52) U.S. Cl. CPC H04W 72/0473; H04W 74/0816

(57) ABSTRACT

A method to optimize roaming of a wireless client in a wireless local area network includes receiving, at a serving access point (AP), a value indicative of transmit power for at least one neighbor AP, and sending the value indicative of transmit power for the at least one neighbor AP from the serving AP to a wireless client that is associated with the serving AP. The wireless client may then calculate a pathloss between the at least one neighbor AP and the wireless client based on the value indicative of transmit power for the at least one neighbor AP less a downlink RSSI of a Clear to Send (CTS) message received from the at least one neighbor AP, and then estimate an uplink RSSI at the at least one neighbor AP based on a value indicative of transmit power for the wireless client less the pathloss.

### CROSS-REFERENCE TO RELATED APPLICATION

This application is a continuation of U.S. Application No. 19/354,061, filed October 9, 2025, which claims priority to U.S. Provisional Patent Application No. 63/717,341, filed November 7, 2024, the contents of both of which is incorporated herein by reference in its entirety.

### TECHNICAL FIELD

The present disclosure relates to operations of a wireless local area network (WLAN).

### BACKGROUND

Networking architectures have grown increasingly complex in communications environments, particularly wireless networking environments, such as those that employ IEEE 802.11 wireless local area network (WLAN) technology, also known as Wi-Fi® wireless networking technology. One feature of a WLAN is the ability of a wireless client device (client) to roam from one wireless access point (AP) to another AP as the client moves in an area covered by the WLAN.

### BRIEF DESCRIPTION OF THE DRAWINGS

FIG. 1 is a diagram depicting a sequence flow for a wireless client, a serving access point (AP) and neighbor APs in connection with client roaming supported by Client Pathloss Estimation Logic and AP Transmit (TX) Power Notification Logic, according to an example embodiment.

FIG. 2 shows a table maintained by Client Pathloss Estimation Logic that may be used to determine pathloss to a given neighbor AP, and to estimate an uplink (UL) Received Signal Strength Indicator (RSSI) value at the given neighbor AP, according to an example embodiment.

FIG. 3 shows elements of a Basic Service Set (BSS) Transition Management (BTM) Request frame or Neighbor Report Response frame that may be employed to supply TX power indications to a wireless client, according to an example embodiment.

FIG. 4 shows elements of a BTM Request frame or Neighbor Report Response frame, in the context of a multilink device (MLD), that may be employed to supply TX power indications to a wireless client, according to an example embodiment.

FIG. 5 shows elements of a Reduced Neighbor Report element that may be employed to supply TX power indications to a wireless client, according to an example embodiment.

FIG. 6A is a flowchart showing a series of operations that may be executed by AP TX Power Notification Logic at a neighbor AP, according to an example embodiment.

FIG. 6B is a flowchart showing a series of operations that may be executed by AP TX Power Notification Logic at a serving AP, according to an example embodiment.

FIG. 6C is a flowchart showing a series of operations that may be executed at Client Pathloss Estimation Logic, according to an example embodiment.

FIG. 7 is a block diagram of a computing device that may be configured to execute AP TX Power Notification Logic or Client Pathloss Estimation Logic, according to an example embodiment.

### DETAILED DESCRIPTION

### Overview

In an embodiment, a method to optimize roaming of a wireless client in a wireless local area network is provided. The method includes receiving, at a serving access point (AP), a value indicative of transmit power for at least one neighbor AP, and sending the value indicative of transmit power for the at least one neighbor AP from the serving AP to a wireless client that is associated with the serving AP. The wireless client may then calculate a pathloss between the at least one neighbor AP and the wireless client based on the value indicative of transmit power for the at least one neighbor AP less a downlink RSSI of a message (e.g., a Clear to Send (CTS) message) received from the at least one neighbor AP, and then estimate an uplink RSSI at the at least one neighbor AP based on a value indicative of transmit power of the wireless clientless the pathloss.

In another embodiment, a device is provided. The device may be a serving AP and includes an interface configured to enable network communications, a memory, and one or more processors coupled to the interface and the memory, and configured to: receive a value indicative of transmit power for at least one neighbor AP, and send the value indicative of transmit power for the at least one neighbor AP from the device to a wireless client. The wireless client may then calculate a pathloss between the at least one neighbor AP and the wireless client based on the value indicative of transmit power for the at least one neighbor AP less a downlink RSSI of a message (e.g., a Clear to Send (CTS) message) received from the at least one neighbor AP, and then estimate an uplink RSSI at the at least one neighbor AP based on a value indicative of transmit power of the wireless client less the pathloss.

### Example Embodiments

In a wireless local area network (WLAN) or Wi-Fi® wireless network, one or more wireless APs provide wireless Radio Frequency (RF) coverage over which one or more wireless devices (e.g., mobile phones, wearable devices, tablets, etc., i.e., clients) can connect to the APs in order to connect to one or more data networks (e.g., the public Internet, an enterprise network operated by an enterprise entity (e.g., a business, institution, university, etc.)), and/or the like. When multiple APs are available, a client may elect, or need, to roam from a currently serving AP to another AP.

When a client is considering roaming, a key metric to consider is the signal strength connectivity to a next AP (i.e., uplink receive signal strength indicator (UL RSSI), downlink RSSI, pathloss, or a function of these, etc.). This is especially the case for a “panic” roam when the client would prefer to obtain measurements on its own schedule and not wait for an AP to serve the client. For example, a probe request/probe response exchange to detect signal strength connectivity is relatively long and slow. Specifically, the client might wait for 5-10msec for a response and the response could be as long as 0.5msec. With low power indoor (LPI)-only clients and composite LPI – standard power (LPI_SP) APs at 6 GHz, the downlink and uplink RSSIs can be wildly different. Similarly, with very low power wearables/Internet of Things (IoT) devices, the downlink RSSI and uplink RSSI can differ greatly. Thus, one goal of the embodiments described herein is to keep a client updated with information sufficient to enable the client to make a better-informed decision about which AP might be best to roam to without having to rely on, e.g., relatively slow probe request/probe response exchanges.

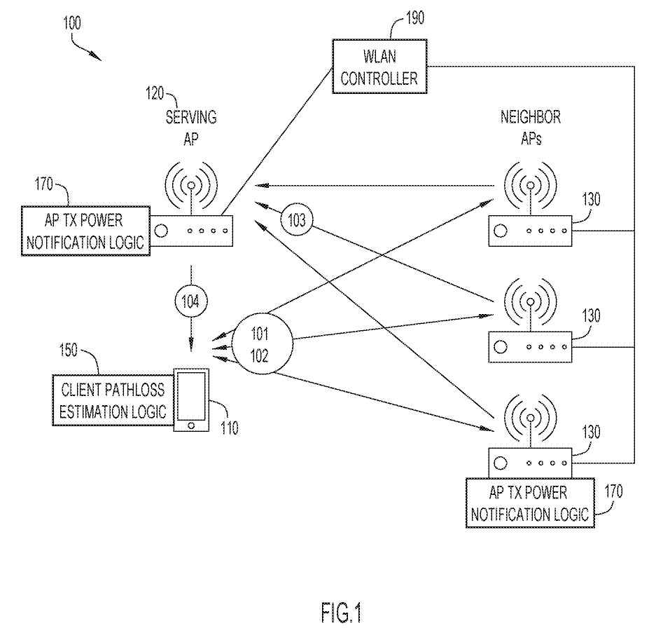

FIG. 1 is a diagram depicting operations in a WLAN 100 including a wireless client 110 (mobile phone, laptop, tablet, etc.), a serving AP 120 (an AP to which the wireless client 110 is presently associated), and neighbor APs 130 in connection with client roaming that is supported by Client Pathloss Estimation Logic 150 and AP TX Power Notification Logic 170, according to an example embodiment. As shown, wireless client 110 hosts Client Pathloss Estimation Logic 150 and serving AP 120 and neighbor APs 130 host AP TX Power Notification Logic 170. A WLAN controller 190 may be in communication with serving AP 120 and neighbor APs 130 or the connectivity between APs may be more direct.

At a high level, Client Pathloss Estimation Logic 150, and instances of AP TX Power Notification Logic 170 operate together to enable wireless client 110 to gain insight into pathloss and RSSI values associated with each neighbor AP 130 while wireless client 110 is still associated with serving AP 120. In this way, wireless client 110 can make a better-informed decision about which neighbor AP 130 to roam to, especially under a panic roam scenario.

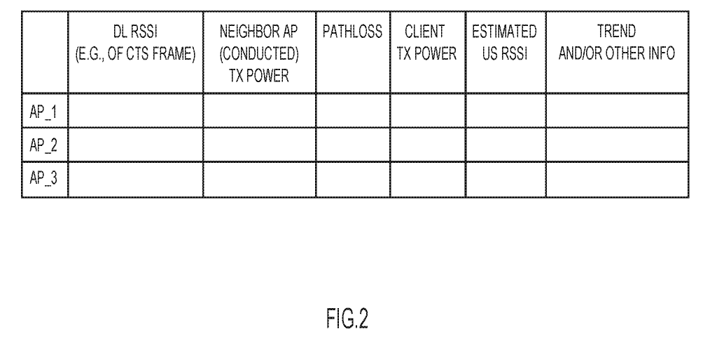

In accordance with an embodiment, at operation 101, wireless client 110 sends a Request-to-Send (RTS) (or other similar frame, such as a Probe Request) to neighbor APs 130, each of which is a potential roaming target AP for wireless client 110. At operation 102, each neighbor AP 130 responds with a Clear-to-Send (CTS) frame or other similar frame, such as an acknowledgment frame, and wireless client 110 detects the respective RSSIs associated with its reception of the CTS or other similar frames. Client Pathloss Estimation Logic 150 may then be configured to add a corresponding RSSI value to a table, database, or the like, as depicted in FIG. 2, which is a table maintained by Client Pathloss Estimation Logic 150 that may be used to estimate pathloss to a given neighbor AP 130, and, further, to estimate an uplink (UL) Received Signal Strength Indicator (RSSI) value with respect to each neighbor AP 130.

At operation 103, and in conjunction with AP TX Power Notification Logic 170, neighbor APs 130 report their respective (e.g., conducted or radiated) transmit (TX) powers to serving AP 120 or to WLAN controller 190, which could then notify serving AP 120 of the TX power values. At operation 104, AP TX Power Notification Logic 170 operating on serving AP 120 is configured to report the TX power information of serving AP 120 and the TX power information of the neighbor APs 130 to wireless client 110 using, e.g., WLAN control or management frames. For example, the TX power information may be supplied to wireless client 110 in sub-elements in Neighbor Report elements in one or more of a Neighbor Report Response or Basic Service Set (BSS) Transition Management (BTM) Query or BTM Request frame. It is noted that operations 103 and/or 104 (receiving and supplying indications of TX power) may precede operations 1 and 2 (e.g., RTS/CTS exchanges). When wireless client 110 receives the respective TX power information indications, Client Pathloss Estimation Logic 150 may add that information, for each neighbor AP 130, to the table depicted FIG. 2. It is noted that AP TX Power Notification Logic 170 is configured to operate on both serving AP 120 and neighbor APs 130 as any AP may become a serving AP after a roaming.

Thus, as shown in the table of FIG. 2, regardless of the order of the foregoing operations, wireless client 110, and particularly Client Pathloss Estimation Logic 150, will now possess, for each neighbor AP 130 (AP_1, AP_2, AP_3, etc.), a downlink RSSI (from, e.g., a measurement related to a received CTS frame) and the (conducted) TX power for each neighbor AP 130. Client Pathloss Estimation Logic 150 is then further configured to estimate the UL RSSI for each neighbor AP 130 as follows. Client Pathloss Estimation Logic 150 first calculates the pathloss between wireless client 110 and each neighbor AP 130 according to:

Pathloss = neighbor AP 130 (e.g., conducted) TX power – DL RSSI related to CTS (or other) frame received from neighbor AP 130.

The resulting pathloss value (or an equivalent parameter such as pathgain, which equals the negative of pathloss) can be added to the table of FIG. 2.

Then, Client Pathloss Estimation Logic 150 may be configured to calculate the estimated UL RSSI for neighbor AP 130 according to:

Estimated UL RSSI = client’s (conducted) TX power – pathloss.

The resulting Estimated UL RSSI can also be added to the table of FIG. 2. The table might also include a summary metric, such as min(DL RSSI, UL RSSI) or some other metric that accounts for both a poor DL RSSI and a poor UL RSSI (and vice versa) (or something equivalent).

Thus, by having serving AP 120, operating with AP TX Power Notification Logic 170, deliver to wireless client 110 an indication of (conducted) TX power for each neighbor AP 130, Client Pathloss Estimation Logic 150 executing on wireless client 110 can estimate the UL RSSI for each neighbor AP 130, enabling wireless client 110 to make a better-informed decision regarding which neighbor AP 130 might be a best candidate at a next roaming decision event. Notably, wireless client 110 can be configured to update the information in the table of FIG. 2 as often as desired, and the periodicity of such an update can be a configuration setting for WLAN 100. Also, the update might be a replacement operation or a filtering (e.g., averaging) operation.

Over time, the table of FIG. 2 can also incorporate or be updated with a “trend” for the values of pathloss and estimated UL RSSI. This trend, and/or other (e.g., Basic Service Set (BSS) load), information can thus inform the client with information such as: for each nearby AP 130, is the RSSI high or increasing, is the BSS load low? In other words, Client Pathloss Estimation Logic 150 can help determine if there is a better neighbor AP 130 right now, or whether a given neighbor AP 130 might become better soon.

According to various embodiments, serving AP 120 may maintain currency of the TX power of neighbor APs 130 in several possible ways.

For example, serving AP 120 may regularly detect the TX power wirelessly (e.g., via an aux radio or serving radio (going briefly off channel if the channels are different), either snooping the beacon or performing a request+response exchange such as an Access Network Query Protocol (ANQP) or probe request+response or a proprietary protocol such as Neighbor Discovery Protocol (available from Cisco, San Jose, CA)).

Serving AP 120 may also, or instead, regularly detect the TX power over the wire/over-the-Distributed System (DS) (e.g., an L2 broadcast, if all APs are on the same subnet).

Serving AP 120 may further, or instead, obtain the TX power from a centralized Radio Resource Manager (RRM) or its delegate, e.g., WLAN controller 190, that sends a new transmit power, such as on-demand whenever the power of neighboring APs 130 is updated. As noted, the RRM may be implemented in the WLAN controller 190, or may be implemented as an artificial intelligence RRM (AI-RRM) in the cloud that might send its decisions directly to serving AP 120.

Serving AP 120 may still further, or instead, obtain the TX power over a Distributed Service (DS)/backhaul exchange between neighboring APs 130 along with other AP information. This approach may be considered more of unicast approach compared to the L2 broadcast mentioned above.

In an embodiment, the TX power value (or indication) might be signaled as a field with length 1 octet with a signed value in 2, 1, or 0.5 dBm increments where -128 or 127 signals "unknown", or fewer bits, such as 4-5-6 bits with an offset (e.g., 5 bits for -6 to 25 dBm in 1 dB steps, and optionally with a variation where the value indicating "-6" signifies "unknown" or, alternatively, “unknown” is signaled by not including the field (e.g., by not including the containing subelement)).

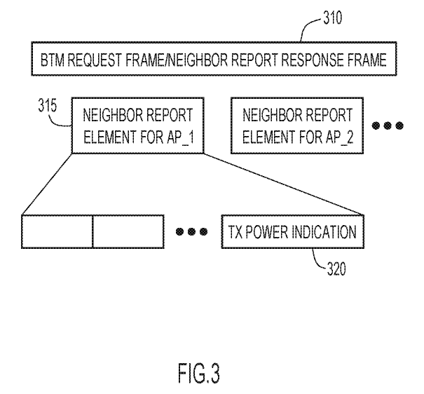

As alluded to above, the indication of TX power can be supplied to wireless client 110 in several possible ways, including those shown in FIGS. 3 - 5.

As shown in FIG. 3, a (conducted) TX power indication 320 for each neighbor AP 130 can be supplied in a field of a neighbor report element 315 (one TX power indication per neighbor) of a modified IEEE 802.11 BTM Request frame or Neighbor Report response 310.

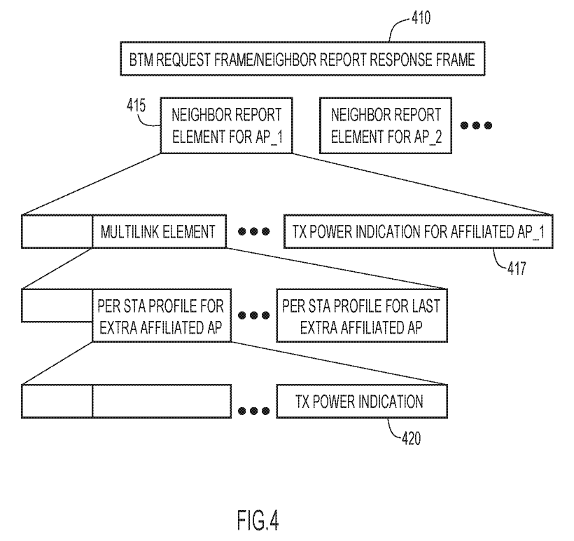

Also, as shown in FIG. 4, if a Neighbor Report element 415 in a BTM Request frame or Neighbor Report response 410 is for an AP multilink device (MLD), the transmit powers for each AP or the AP MLD can be indicated as follows: a TX power indication is provided in a subelement 417 in the Neighbor Report element 415 for the AP signaled directly by the Neighbor Report element. The TX power of APs affiliated with the same AP MLD as the AP signaled directly by the Neighbor Report element can be sent as subelements in the Per-STA Profile subelements of the Multi-Link element in the same Neighbor Report element, as shown by TX power indication 420

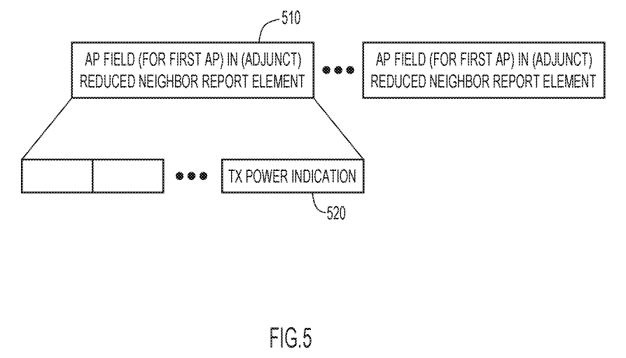

In still another approach, as shown in FIG. 5, a (conducted) TX power indication 520 for each neighbor AP 130 can be supplied in a field of a modified IEEE 802.11 Reduced Neighbor Report element 510, which may be supplied in a beacon frame from serving AP 120.

In yet another approach, a newly-specified Reduced Neighbor Report (RNR) may be defined to include the TX power indications. In such a modification, the "TBTT Information Length" subfield could be sent to N+1, which contains the same fields as signaled by the "TBTT Information Length" == N plus this extra octet. Presently, the largest value for N is 16, so N=16 would lead to 17 and is reasonably safe. Other values could be allocated too, such as 2+1 or 9+1. In another variant, this field could be combined with other fields or have many reserved bits, so that it lasts P = 2-3-4 octets. Then the "TBTT Information Length" subfield is set to N+P, as long as N+P is presently a reserved value.

Alternatively, serving AP 120 and AP TX Power Notification Logic 170 may be configured to co-transmit an adjunct of the RNR that provides information beyond what is presently-specified IEEE 802.11 RNR.

In the replacement or adjunct RNR approaches, two possible choices for this new field are:

the field is always-present in the element; or

the field is optionally present in the element field, and the field's presence is signaled by a "presence bit" which is set, e.g., to 1 to indicate the presence of this field (or the octet holding it) and is set, e.g., to 0 to indicate the absence of this field (or the octet holding it).

In another embodiment, the (conducted) TX power indication for the neighbor APs 130 could be indicated in the CTS frame of the RTS/CTS exchange that serving AP 120 initiates with each neighbor AP 130, or some other control frame exchange could be defined (such as Buffer Status Report Poll frame followed by Multi-STA Block Ack), where the second control frame carries the TX power.

In yet another embodiment, the (conducted) TX power information for neighbor APs 130 can also be signaled in any other frame that provides a recommendation for candidate neighboring APs for roaming, such as a Link Reconfiguration Notify frame or another management frame recommending neighboring APs for roaming.

It is noted that the (conducted) TX power (and thus its representative information or indication) can be influenced by several factors. The following discusses reporting power versus different physical layer protocol data unit (PPDU) parameters (e.g., modulation and coding scheme (MCS), number of spatial streams (NSS), and bandwidth (BW)).

An 802.11 compliant wireless client 110 typically has a maximum transmit power for Orthogonal Frequency Division Multiplexing (OFDM) PPDUs under ideal circumstances, but lower (and sometimes higher) power in other circumstances, including:

Regulatory limitations (lower power)

Nearer to a band edge (lower power)

Higher MCS (lower power)

More spatial streams (could be lower or higher power)

Embodiments described herein provide possible ways to signal these variations, with trade-offs between comprehensiveness and compactness, noting that beacons and CTS frames tend to be sent at a low MCS, 1SS and 20 MHz (but some beacons are sent as non-HT (high throughput) duplicate mode so could span wider the bandwidths of 40-80-160-320 MHz, especially at 6GHz due to associated regulations; and similar reasons might motivate use of RTS+CTS sent in duplicate non-HT mode too so could span wider the bandwidths of 40-80-160-320 MHz).

The following are possible approaches for sending (signaling) the (conducted) TX power for neighbor APs 130:

1) 1 value for MCS0, 20 MHz, 1SS only. Clients hearing anything else can still use this number but with caution.

2) 1 value for MCS, BW, NSS of beacon (and the same for CTS or other control response frame if sent in a PPDU with the same parameters and APs are assumed to use the same parameters as a matter of course). In high density, the beacon MCS might be 6/12/24 Mbps (or even 36/48/54 Mbps). Clients hearing anything else can still use this number but with caution.

3) Three values for MCS=6/12/24 Mbps, BW=20 MHz, NSS=1. Clients hearing anything else can still use one of these numbers, such as the closest in terms of MCS, but with caution.

4) “N” + N values for the first N of 6/12/24/36/48/54 Mbps, or some subset thereof, BW=20 MHz, NSS=1. Clients hearing anything else can still use one of these numbers, such as the closest in terms of MCS, but with caution

5) Variation of 3) or 4): one absolute value then 2 (for “3”) or N-1 (for “4”) other relative values: i.e., how many dB to subtract away from that first value to get the next 2 or next N-1 values. These relative values can be compressed more – e.g., 1/2/3/4 bits instead of 4/5/6 bits.

6) Variation of 3) or 4): all relative values, relative to the power advertised by serving AP 120 that is sending this report: i.e., how many dB to add to/subtract away from that AP’s values to get the next 2 or next N-1 values. These relative values can be compressed more – e.g., 1/2/3/4 bits instead of 4/5/6/8 bits.

7) Variations of 1/2/3/4 (+5/6): Adjunct table of transmit power reduction with MCS. Take the given value (e.g., 6 Mbps) then subtract away the MCS-dependent value to get the transmit power for the actual MCS.

8) Like 7), but now an adjunct table for NSS. This might have signed values – power can increase or decrease with higher NSS. the same may be applied to BW: adjunct table of transmit power reduction with BW. Take the given value (e.g., 20 MHz) then add a (possibly signed) BW-dependent value to obtain the transmit power for the actual BW. A variation of this is for the table to report the power change over the primary 20 MHz when transmitting at another bandwidth with respect to the power transmitted over the primary 20 MHz when transmitting at the reference 20 MHz bandwidth.

9) Complete table for transmit power for each (MCS, BW, NSS)-tuple supported by the AP. The max supported MCS, BW, NSS may be signaled too.

10) Partial table for the (MCS, BW, NSS)-tuples supported by the AP and commonly used for RSSI measurement (e.g., all up to some max reported MCS, BW, NSS, where the max reported MCS, BW, NSS are signaled too. Clients hearing anything else can still use a nearby number but with caution.

11) Same as 10), but also including a minimum for one or more of the MCS, BW, NSS parameters (especially a minimum MCS, since in high density the AP may not use the lowest rates).

12) For 1+2 Mbps (DSSS PHY format) and 5.5+11 Mbps (CCK PHY format), these are only used with 1SS and approx. 20 MHz (really 22 MHz). Here 2) can work. For the other scenarios, they could be signaled as a separate list of four transmit powers, on top of what is described for 1), 3-11), or some subset thereof (e.g., 1 and 5.5 Mbps). Clients hearing anything else can still use a nearby number but with caution.

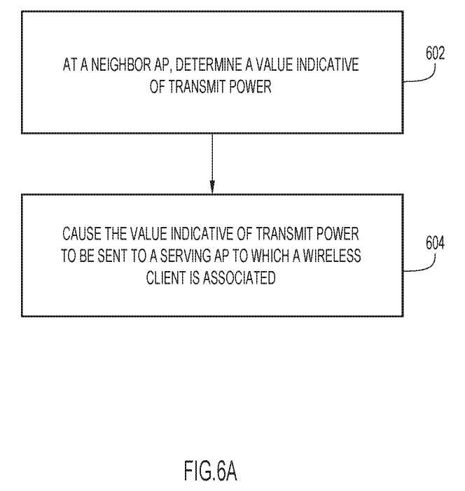

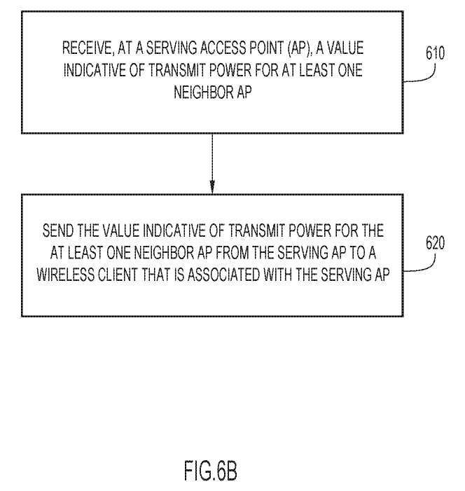

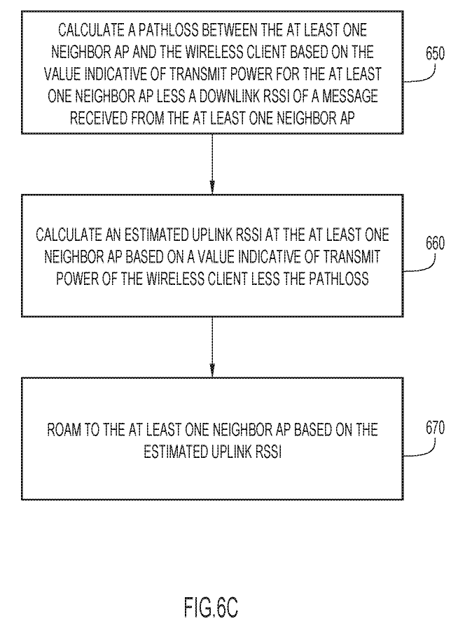

FIG. 6A is a flowchart showing a series of operations that may be executed by AP TX Power Notification Logic at a neighbor AP, according to an example embodiment. As shown, at 602, an operation is configured, at a neighbor AP, to determine a value indicative of (conducted) transmit power. And, at 604, an operation is configured to cause the value indicative of (conducted) transmit power to be sent a serving AP to which a wireless client is associated. The value could be sent directly, via the cloud, or the WLAN controller 190, among other mentioned approaches.

FIG. 6B is a flowchart showing a series of operations that may be executed by AP TX Power Notification Logic 170 at a serving AP, according to an example embodiment. As shown, at 610, an operation is configured to receive, at a serving access point (AP), a value indicative of transmit power for at least one neighbor AP, and, at 620, an operation is configured to send the value indicative of transmit power for the at least one neighbor AP from the serving AP to a wireless client that is associated with the serving AP.

FIG. 6C is a flowchart showing a series of operations that may be executed by Client Pathloss Estimation Logic 150, according to an example embodiment. As shown, at 650, an operation is configured to calculate a pathloss between the at least one neighbor AP and the wireless client based on the value indicative of transmit power for the at least one neighbor AP less a downlink RSSI of, e.g., a Clear to Send (CTS) or other message received from the at least one neighbor AP. At 660, an operation is configured to calculate an estimated uplink RSSI at the at least one neighbor AP based on a value indictive of a transmit power of the wireless client less the pathloss. And, at 670, an operation is configured to roam to the at least one neighbor AP based on the estimated uplink RSSI.

Thus, those skilled in the art will appreciate that the embodiments described herein enable a client to select, during pre-roaming, on the client's schedule, and with minimal overhead and delays, a potential AP to roam to, based on an estimate of the pathloss between the potential AP to roam to and the client, and thus based on an estimate UL RSSI at the potential AP to roam to. This functionality may be particularly useful for very low power wearables/IoT and LPI-only clients.

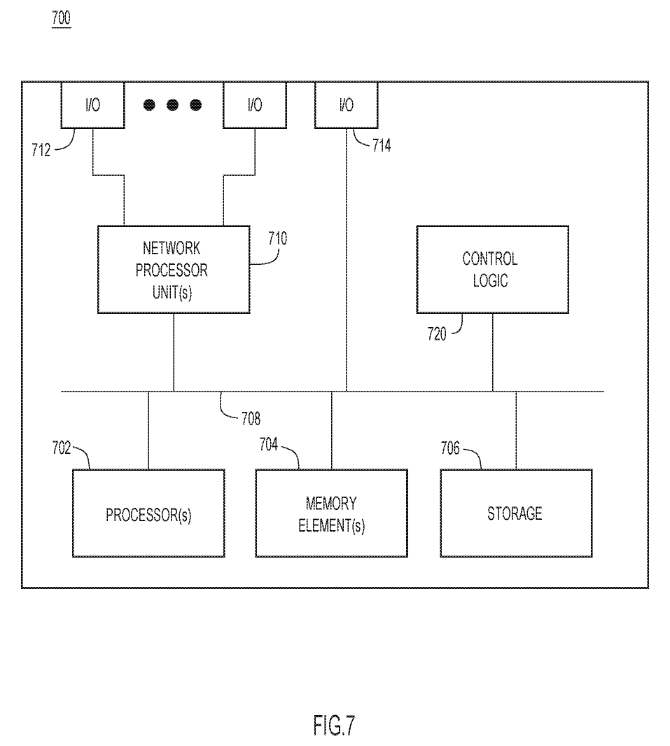

FIG. 7 is a block diagram of a computing device that may be configured to execute Client Pathloss Estimation Logic 150 or AP TX Power Notification Logic 170, according to an example embodiment. In various embodiments, a computing device, such as computing device 700 or any combination of computing devices 700, may be configured as any entity/entities as discussed for the techniques depicted in connection with FIGS. 1-5, 6A, 6B and 6C in order to perform operations of the various techniques discussed herein.

In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720 (which could be Client Pathloss Estimation Logic 150 or AP TX Power Notification Logic 170). In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa) or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly be connected utilizing any algorithms, communication protocols, interfaces, etc. (proprietary and/or non-proprietary) that allow for the exchange of data and/or information.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

In sum, a method may include receiving, at a serving access point (AP), a value indicative of transmit power for at least one neighbor AP, and sending the value indicative of transmit power for the at least one neighbor AP from the serving AP to a wireless client that is associated with the serving AP.

In the method, the value indicative of transmit power may be a value indicative of conducted transmit power.

In the method, the value indicative of the transmit power may be a transmit power that is used by the at least one neighbor AP to transmit a Clear to Send (CTS) message in response to a Request to Send (RTS) message sent by the wireless client.

The method may further include receiving the value indicative of transmit power for the at least one neighbor AP from a controller that controls the serving AP and the at least one neighbor AP.

The method may further include receiving the value indicative of transmit power for the at least one neighbor AP from the at least one neighbor AP.

The method may further include sending the value indicative of transmit power for the at least one neighbor AP as part of at least one of a Neighbor Report Response frame a Basic Service Set (BSS) Transition Management (BTM) frame, and a Reduced Neighbor Report (RNR) frame in a beacon signal transmitted by the serving AP.

In the method, the value indicative of transmit power may be a value indicative of transmit power over a primary 20 MHz channel.

The method may further include the wireless client calculating a pathloss between the at least one neighbor AP and the wireless client based on the value indicative of transmit power for the at least one neighbor AP less a downlink received signal strength indicator (RSSI) of a message received from the at least one neighbor AP.

The method may further include the wireless client calculating an estimated uplink RSSI at the at least one neighbor AP based on a value indicative of transmit power of the wireless client less the pathloss.

The method may further include selecting the at least one neighbor AP as a target AP to which to roam based on the estimated uplink RSSI at the at least one neighbor AP.

In an embodiment, a device may be provided and may include an interface configured to enable network communications, a memory, and one or more processors coupled to the interface and the memory, and configured to: receive a value indicative of transmit power for at least one neighbor AP, and send the value indicative of transmit power for the at least one neighbor AP from the device to a wireless client, wherein the device is a serving access point (AP) to which the wireless client is associated.

In the device, the value indicative of transmit power may be a value indicative of conducted transmit power.

In the device, the value indicative of transmit power may be a transmit power used by the at least one neighbor AP to transmit a Clear to Send (CTS) message in response to a Request to Send (RTS) message sent by the wireless client.

In the device, the one or more processors may be further configured to receive the value indicative of transmit power for the at least one neighbor AP from a controller that controls the device and the at least one neighbor AP.

In the device, the one or more processors may be further configured to receive the value indicative of transmit power for the at least one neighbor AP from the at least one neighbor AP.

In the device, the one or more processors may be further configured to send the value indicative of transmit power for the at least one neighbor AP as part of at least one of a Neighbor Report Response frame, a Basic Service Set (BSS) Transition Management (BTM) frame, and as part of a Reduced Neighbor Report (RNR) frame in a beacon signal transmitted by the device.

In the device, the value indicative of transmit power may be a value indicative of transmit power over a primary 20 MHz channel.

In still another embodiment, one or more non-transitory computer readable storage media encoded with instructions are provided, and the instructions, when executed by a processor, cause the processor to: receive, at a serving access point (AP), a value indicative of transmit power for at least one neighbor AP, and send the value indicative of transmit power for the at least one neighbor AP from the serving AP to a wireless client that is associated with the serving AP.

For the one or more non-transitory computer readable storage media, the value indicative of transmit power may be a value indicative of conducted transmit power.

In the one or more non-transitory computer readable storage media, the instructions may be configured to send the value indicative of transmit power for the at least one neighbor AP as part of at least one of a Neighbor Report Response frame, a Basic Service Set (BSS) Transition Management (BTM), and as part of a Reduced Neighbor Report (RNR) frame in a beacon signal transmitted by the serving AP.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
establishing, by a first access point, an association with a wireless station;
accessing, by the first access point, transmit power information for one or more neighboring access points, the one or more neighboring access points neighboring the first access point;
wherein the transmit power information for each neighboring access point of the one or more neighboring access points comprises a value indicating a transmit power; and
transmitting, by the first access point, a message to the wireless station,
wherein the message comprises a neighbor report element for at least one of the one or more neighboring access points,
each neighbor report element including the transmit power information for a corresponding neighboring access point of the one or more neighboring access points.

2. The method of claim 1 wherein the message comprises a neighbor report response transmitted in response to a neighbor report request of the wireless station.

3. The method of claim 1 wherein the message comprises a Basic Service Set (BSS) Transition Management (BTM) request.

4. The method of claim 1 further comprising:
receiving, by the first access point, a first wireless frame from a second wireless station; and
transmitting, by the first access point, a second wireless frame in response to the first wireless frame, the second wireless frame allowing the second wireless station to measure received signal strength associated with the first access point.

5. The method of claim 1 further comprising:
receiving, by the first access point, a Request-to-Send (RTS) frame from a second wireless station; and
transmitting, by the first access point a Clear-to-Send (CTS) frame in response to the RTS frame.

6. The method of claim 1 wherein the value indicating a transmit power is a value indicative of conducted transmit power.

7. The method of claim 1 wherein the value indicating a transmit power is a value indicative of transmit power over a primary 20 MHz channel.

8. The method of claim 1 wherein the value indicating a transmit power is a value indicative of conducted transmit power of a beacon frame.

9. An access point comprising:
one or more memories; and
one or more processors communicatively coupled to the one or more memories, wherein the one or more processors are configured to, individually or collectively, perform operations comprising:
establishing, by the access point, an association with a wireless station;
accessing, by the access point, transmit power information for one or more neighboring access points, the one or more neighboring access points neighboring the access point;
wherein the transmit power information for each neighboring access point of the one or more neighboring access points comprises a value indicating a transmit power; and
transmitting, by the access point, a message to the wireless station,
wherein the message comprises a neighbor report element for at least one of the one or more neighboring access points,
each neighbor report element including the transmit power information for a corresponding neighboring access point of the one or more neighboring access points.

10. The access point of claim 9 wherein the message comprises a neighbor report response transmitted in response to a neighbor report request of the wireless station.

11. The access point of claim 9 wherein the message comprises a Basic Service Set (BSS) Transition Management (BTM) request.

12. The access point of claim 9, the operations further comprising:
receiving, by the access point, a first wireless frame from a second wireless station; and
transmitting, by the first access point, a second wireless frame in response to the first wireless frame, the second wireless frame allowing the second wireless station to measure received signal strength associated with the access point.

13. The access point of claim 9, the operations further comprising:
receiving, by the access point, a Request-to-Send (RTS) frame from a second wireless station; and
transmitting, by the access point a Clear-to-Send (CTS) frame in response to the RTS frame.

14. The access point of claim 9 wherein the value indicating a transmit power is a value indicative of conducted transmit power.

15. The access point of claim 9 wherein the value indicating a transmit power is a value indicative of transmit power over a primary 20 MHz channel.

16. The access point of claim 9 wherein the value indicating a transmit power is a value indicative of conducted transmit power of a beacon frame.

17. One or more non-transitory computer readable storage media encoded with instructions that, when executed by a processor of an access point, cause the processor to perform operations comprising:
establishing, by the access point, an association with a wireless station;
accessing, by the access point, transmit power information for one or more neighboring access points, the one or more neighboring access points neighboring the access point;
wherein the transmit power information for each neighboring access point of the one or more neighboring access points comprises a value indicating a transmit power; and
transmitting, by the access point, a message to the wireless station,
wherein the message comprises a neighbor report element for at least one of the one or more neighboring access points,
each neighbor report element including the transmit power information for a corresponding neighboring access point of the one or more neighboring access points.

18. The one or more non-transitory computer readable storage media of claim 17 wherein the message comprises a neighbor report response transmitted in response to a neighbor report request of the wireless station.

19. The one or more non-transitory computer readable storage media of claim 17 wherein the message comprises a Basic Service Set (BSS) Transition Management (BTM) request.

20. The one or more non-transitory computer readable storage media of claim 17, the operations further comprising:
receiving, by the access point, a first wireless frame from a second wireless station; and
transmitting, by the first access point, a second wireless frame in response to the first wireless frame, the second wireless frame allowing the second wireless station to measure received signal strength associated with the access point.

21. The one or more non-transitory computer readable storage media of claim 17, the operations further comprising:
receiving, by the access point, a Request-to-Send (RTS) frame from a second wireless station; and
transmitting, by the access point a Clear-to-Send (CTS) frame in response to the RTS frame.

22. The one or more non-transitory computer readable storage media of claim 17 wherein the value indicating a transmit power is a value indicative of conducted transmit power.

23. The one or more non-transitory computer readable storage media of claim 17 wherein the value indicating a transmit power is a value indicative of transmit power over a primary 20 MHz channel.

24. The one or more non-transitory computer readable storage media of claim 17 wherein the value indicating a transmit power is a value indicative of conducted transmit power of a beacon frame.
